(19) United States
(12) Patent Application Publication
(10) Pub. No.: US 2013/0020775 A1
(43) Pub. Date: Jan. 24, 2013

(54) HALF AXLE, AND VEHICLE COMPRISING AT LEAST ONE SUCH HALF AXLE

(71) Applicant: Slaheddine Beji, Vienne (FR)

(72) Inventor: Slaheddine Beji, Vienne (FR)

(73) Assignee: Haulotte Group, L'Horme (FR)

(21) Appl. No.: 13/531,287

(22) Filed: Jun. 22, 2012

(30) Foreign Application Priority Data
Jun. 23, 2011 (FR) 11 55541

(51) Int. Cl. B60B 35/10; B62D 5/00; B66F 11/04

(52) U.S. Cl. 280/43; 180/400

(57) ABSTRACT

The present invention relates to a half axle articulated on a structural element of a vehicle, comprising a wheel rotatably movable around an axis of rotation relative to a shaft the structural element defining a reference plane substantially parallel to the ground when the wheel rests on the ground, also comprising a pivot system for pivoting relative to the structural element around a pivot axis the half axle also comprises an actuating system including means for translating the wheel along a hoisting axis permanently tilted by an incline angle comprised between 60 degrees and 90 degrees, relative to the reference plane. The invention also relates to a vehicle, equipped with a chassis comprising at least one structural element also equipped with at least one half.

This application claims priority under 35 U.S.C. §119 to French Patent Application No. 1155541, filed on Jun. 23, 2011, which is incorporated herein by reference.

The invention relates to an extendable and retractable half axle. The invention also relates to a vehicle comprising at least one such half axle. The invention pertains to the field of hoisting vehicles and engines, in particular aerial lifts for people.

Traditionally, an aerial lift comprises a motorized chassis, wheels, a tower pivoting at 360 degrees on the chassis, a telescoping arm articulated on the tower, and a moving platform arranged at the end of the telescoping arm. Such a lift must be able to circulate easily in a narrow passageway and penetrate a container for loading or unloading. The length and width of the lift must therefore be reduced, while preserving a high hoisting performance level.

The lift must also have significant stability, as there is a risk of tilting during use, for example when the telescoping arm is inclined too much. Such tilting absolutely must be avoided, in particular when an operator is on the moving platform at a height. In practice, the stability increases with the distance between the bearing points of the lift on the ground, i.e. the wheels equipping the chassis. Moving the wheels apart makes it possible to improve the stability during use, but increases the bulk of the lift at the same time.

Thus, depending on the usage conditions, a compromise is sought between two crucial and contradictory parameters: the stability and the bulk of the lift.

In a known manner, an aerial lift can be equipped with extendable and retractable axles. For example, each axle is positioned in a box and moved by a cylinder. When the axles are retracted, in particular when the lift is moved, its lengthwise bulk is reduced. When the axles are extended, in particular in the working position of the lift, its stability is improved. Such axles are poorly suited to certain settings, for example narrow passages, where the axles cannot be extended, or slightly irregular terrain. Furthermore, the extension and retraction movements of the axles can cause scraping of the wheels, which may damage the floor and the wheels.

U.S. Pat. No. 4,395,191 describes a vehicle, of the public works excavator type, comprising two pairs of legs articulated on a chassis. Each leg can move in the vertical and horizontal directions and supports a wheel at its end. In particular, each leg is articulated along a pivot link with a horizontal axis and a link with a substantially vertical axis relative to the chassis. Furthermore, two of the legs are telescoping. In this way, the wheels of the vehicle can follow the height differences of the terrain. The wheelbase of the vehicle is reduced when the wheels are adjusted to the incline of the terrain, with a risk of 35 tilting. The pivot links absorb significant forces due to the weight of the vehicle and its component elements, in particular, when the wheels of the vehicle are greatly spaced apart. This is not satisfactory, in particular in terms of safety.

The aim of the present invention is to propose a half axle making it possible to adapt the lift to its environment, while procuring improved stability, satisfactory safety, and a reduced bulk, as a function of the usage conditions of that lift.

To that end, the invention relates to a half axle articulated on a structural element of a vehicle, the half axle comprising a wheel rotatably movable around an axis of rotation relative to a shaft, the structural element defining a reference plane substantially parallel to the ground when the wheel rests on the ground, the half axle also comprising a pivot system for pivoting relative to the structural element around a pivot axis, wherein the half axle also comprises an actuating system including means for translating the wheel along a hoisting axis permanently tilted by an incline angle comprised between 60 degrees and 90 degrees, inclusive, relative to the reference plane.

In this way, the half axle according to the invention can assume different configurations adapted to the specific usage conditions of the vehicle, such as an aerial lift for people. The wheels can be extended and retracted relative to the reference plane, in particular in the vertical direction, as a function of the height differences in the terrain. The incline range of the hoisting axis, which is stationary relative to the reference plane, gives the half axle a satisfactory compromise between mobility, stability, and resistance to the 20 forces resulting from the weight of the lift. The half axle also makes it possible to monitor the extension ratio of the path and wheelbase of the lift, and therefore to obtain a good compromise between stability and bulk. In this way, the half axle is versatile and easily adaptable to the different environments in which the lift may be used.

According to other advantageous features of the invention, considered alone or in combination:
The pivot axis of the half axle is perpendicular to the reference plane and stationary relative to the structural element and the hoisting axis of the actuating system is substantially perpendicular to the reference plane, with the incline angle equal to 90 degrees.
The actuating system comprises a cylinder that extends along the hoisting axis, preferably a hydraulic cylinder.
The half axle also comprises rotating means for rotating the wheel around the hoisting axis.
The half axle also comprises a system for extending and retracting the wheel relative to the structural element along a sliding axis parallel to the reference plane.
The half axle comprises means for measuring pressure or forces exerted between the ground and the half axle along a measuring axis perpendicular to the reference plane.
The half axle comprises rotation means for rotating around axes only perpendicular to the reference plane and translation means, in particular a telescoping translation along an axis perpendicular to the reference plane and a telescoping translation along an axis parallel to the reference plane.

The invention also relates to a method for using a half axle as described above, said half axle including means for rotating the wheel around the hoisting axis, said method comprising at least the following successive steps:
a1) the pivot system receives an order to pivot the half axle around the pivot axis and informs the rotating means for rotating the wheel around the hoisting axis,
b1) the rotating means move the axis of rotation of the wheel until said axis of rotation is aligned in a direction perpendicular to the pivot axis,
c1) the pivot system pivots the wheel relative to the structural element according to the order received in step a1).

The invention also relates to a method for using a half axle as described above, said half axle comprising a system for extending and retracting the wheel relative to the structural element along a sliding axis parallel to the reference plane, the half axle also including rotating means for rotating the wheel around the hoisting axis, said method comprising at least the following successive steps:
a2) the extension and retraction system receives an order to extend or retract the wheel along the sliding axis and informs the rotating means for rotating the wheel around the hoisting axis,
b2) the rotating means move the axis of rotation of the wheel until said axis of rotation is aligned in a direction perpendicular to the sliding axis,
c2) the extension and retraction system extends or retracts the wheel relative to the structural element according to the order received in step a2).

Preferably, this method also comprises a step d2) following step c2), this step d2) consisting of moving the axis of rotation of the wheel, under the action of the rotating means around the hoisting axis, until said axis of rotation reaches a position corresponding to that of step a2) or another predefined position.

The invention also relates to a vehicle, in particular of the aerial lift type, equipped with a chassis comprising at least one structural element. The vehicle is also equipped with at least one half axle as described above, the or each half axle being articulated to one of the structural elements of the chassis.

Advantageously, the vehicle comprises at least four half axles, each half axle being articulated to one of the structural elements of the chassis and being mechanically independent of the other half axles equipping the vehicle.

Owing to the half axles according, to the invention, the vehicle is easy to reconfigure, while having a high level of stability and a reduced bulk, as a function of the usage conditions.

In the case of a vehicle comprising at least four half axles, preferably, at least four of the half axles each comprise means for measuring pressure or forces exerted between the ground and the half axle along a measuring axis perpendicular to the reference plane and the vehicle comprises an electronic management unit that is connected to the measuring means and configured to determine a position of the center of gravity of the vehicle and/or a tilt percentage of the vehicle.

The invention also relates to a method for using a vehicle as described above, comprising at least four half axles, wherein when one of the half axles is deployed or retracted, at least three wheels of the vehicle are bearing on the ground, while the wheel belonging to the half axle being deployed or retracted is horizontally and/or vertically mobile at a distance from the ground. This method thereby avoids damaging the ground during movements of the wheel.

The invention will be better understood upon reading the following description, provided solely as non-limiting examples and done in reference to the appended drawings, in which:

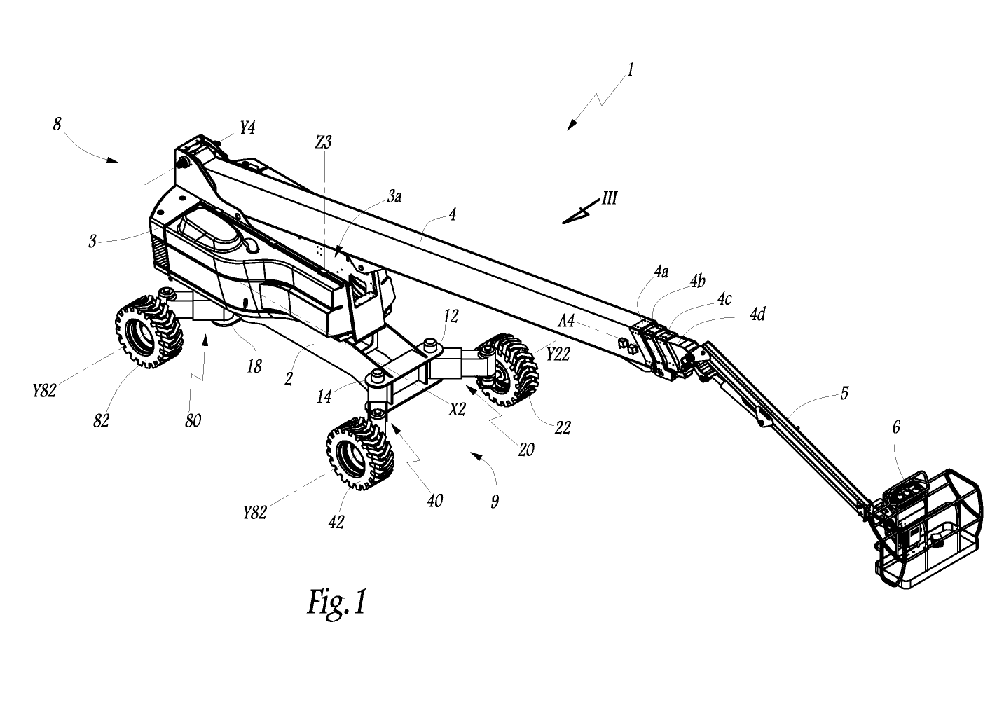

FIG. 1 is a perspective view of an aerial lift according to the invention, equipped with four half axles also according to the invention;

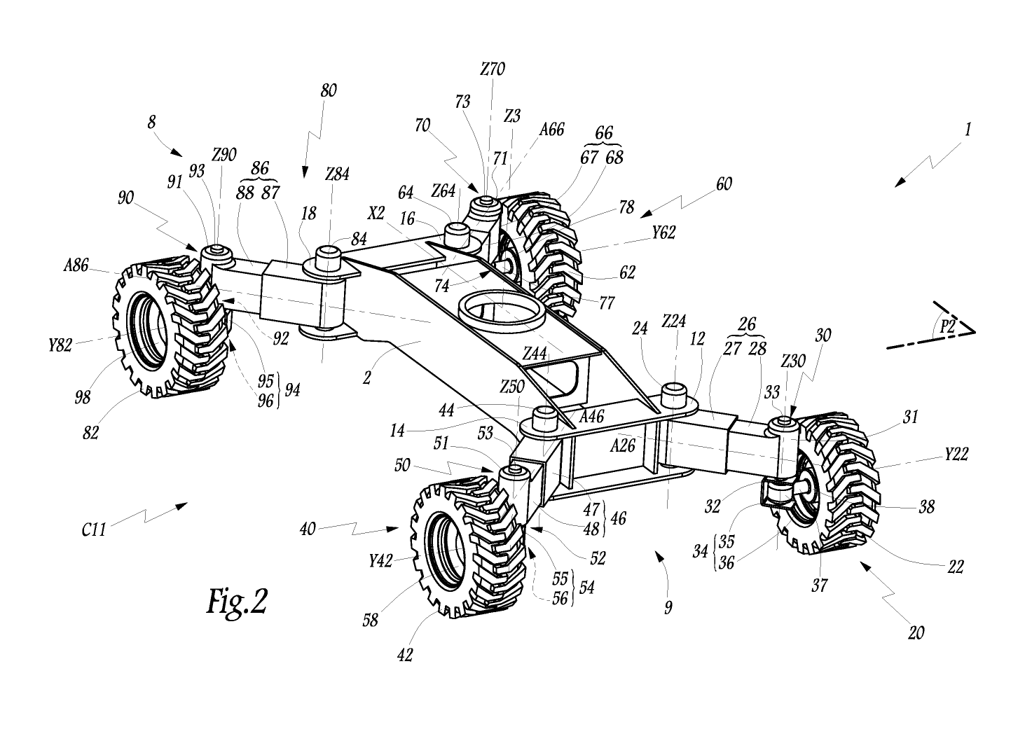

FIG. 2 is a partial perspective view at another angle of the lift of FIG. 1, showing the four half axles articulated on the chassis;

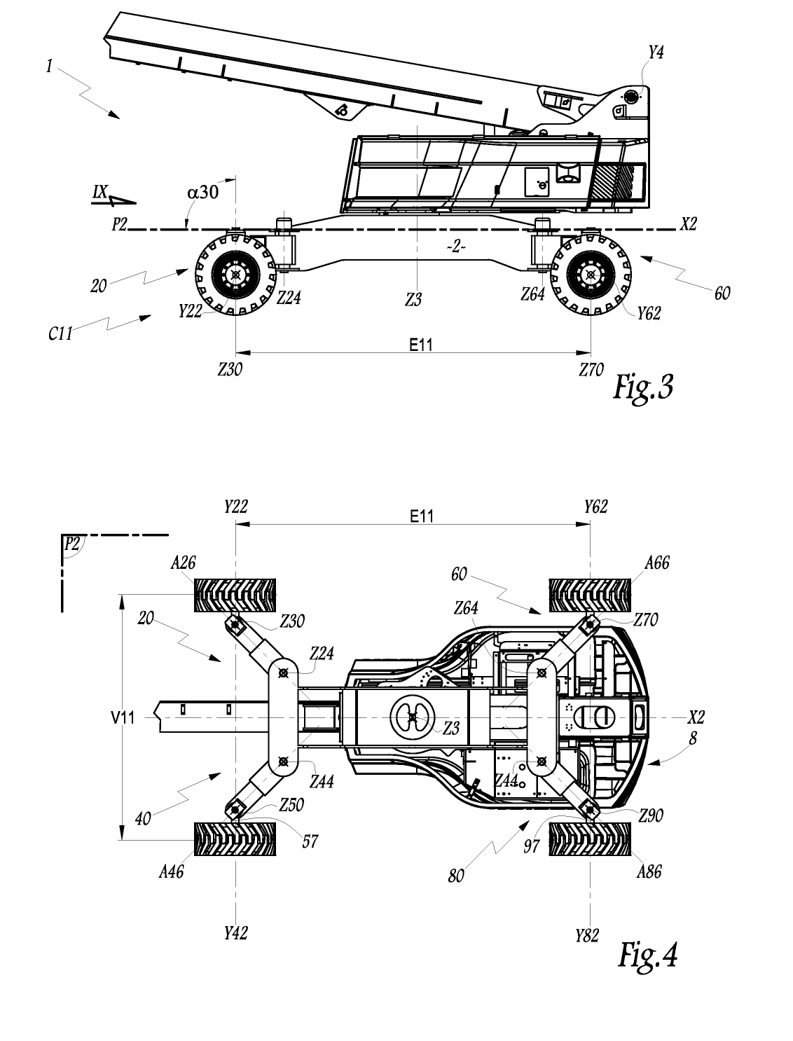

FIG. 3 is a side view along arrow III of FIG. 1, showing the lift in the extended configuration;

FIG. 4 is a bottom view of the lift of FIG. 3;

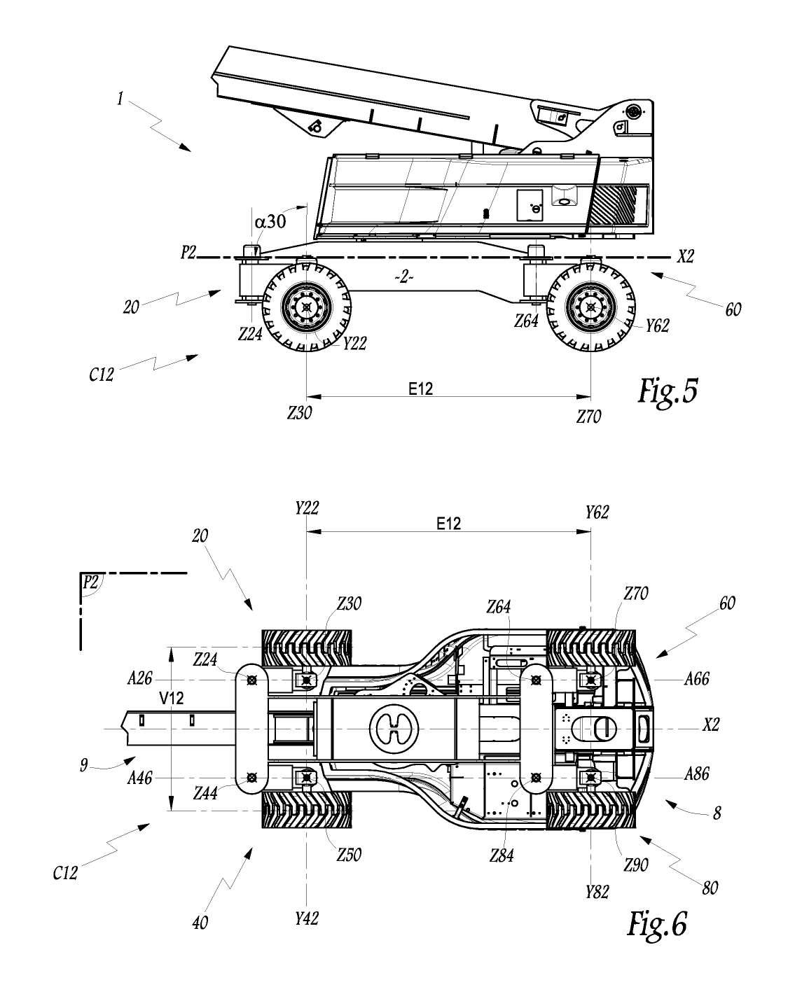

FIGS. 5 and 6 are views respectively similar to FIGS. 3 and 4 of the lift in the compact configuration;

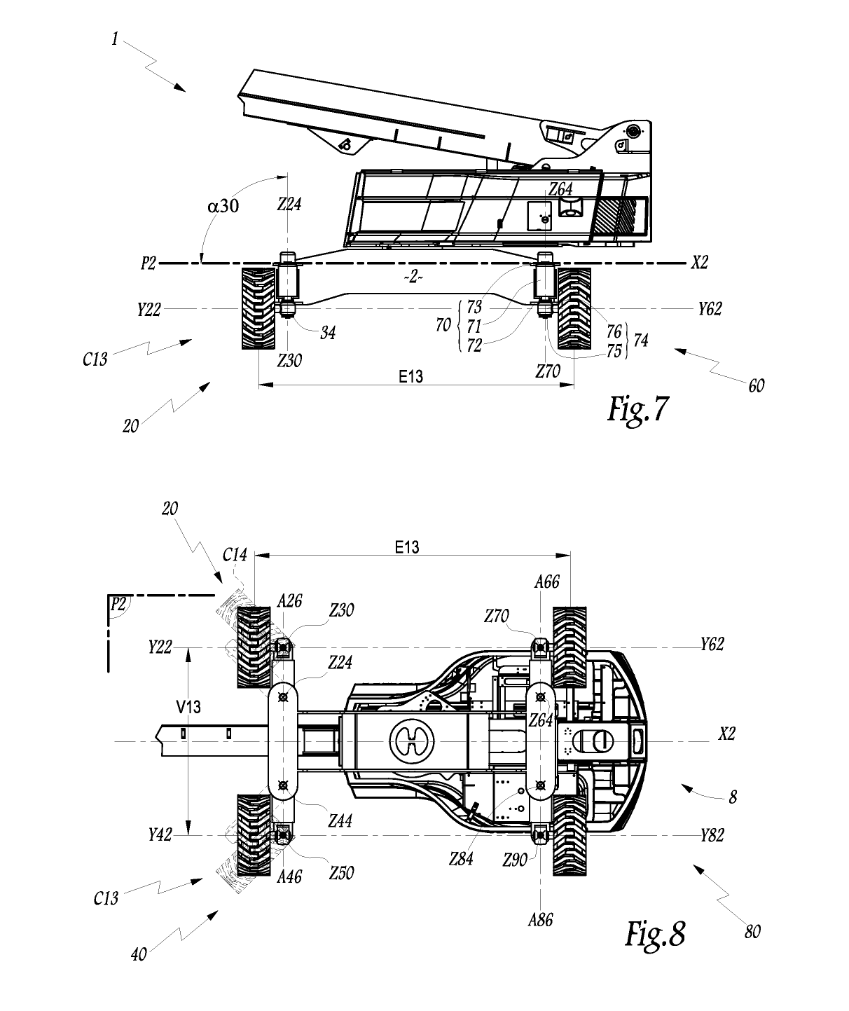

FIGS. 7 and 8 are views respectively similar to FIGS. 3 and 4 of the lift in the lateral movement configuration;

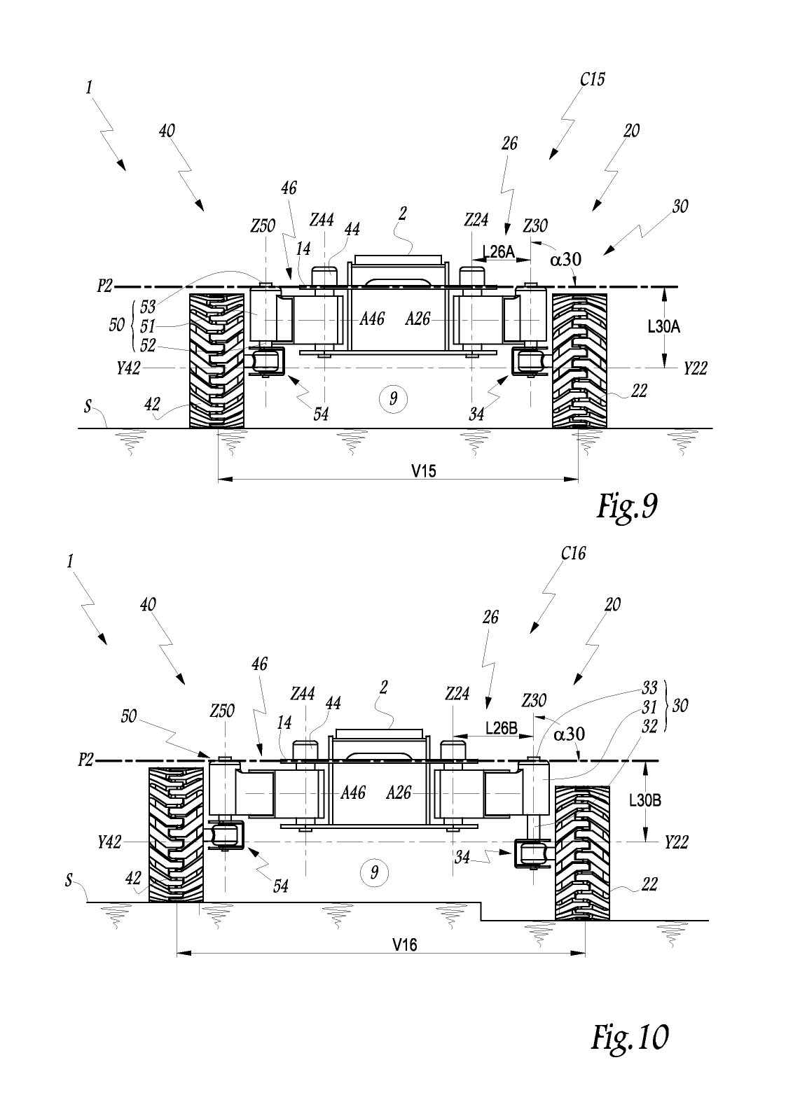

FIG. 9 is a front view of the lift along arrow IX in FIG. 3, showing an intermediate configuration before extension of the half axles in the extended configuration of FIG. 3;

FIG. 10 is a view similar to FIG. 9, showing one of the half axles in a configuration adapted to a variation in the relief of the ground; and

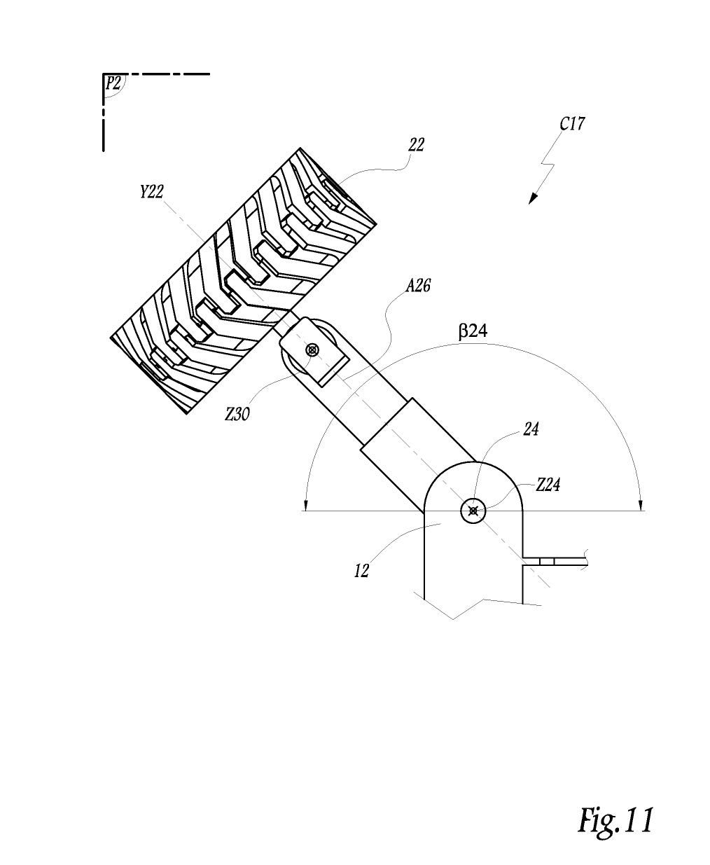

FIG. 11 is an enlarged partial view of the bottom of the lift, showing one of the half axles in the pivot configuration relative to the chassis.

FIGS. 1 to 11 show a vehicle 1 of the personnel aerial lift type according to the invention.

The lift 1 is equipped with four half axles 20, 40, 60, 80, also according to the invention, mounted on a motorized chassis 2. X2 denotes the central longitudinal axis of the chassis 2. The motor means of the chassis 2, not shown, can comprise an internal combustion engine or an electric motor. An electronic central processing unit, a hydraulic reservoir, a fuel tank, and/or a set of electric batteries can also be mounted on the chassis

As shown in FIG. 1, a tower 3 is arranged on the chassis 2, said tower being able to rotate 360 degrees around a vertical axis of rotation Z3. Preferably, the tower 3 is actuated by hydraulic means, not shown. A telescoping arm 4 is articulated on the tower around an axis Y4 perpendicular to the axis Z3. In the idle position, the arm 4 can be housed in a longitudinal housing 3a formed in the tower 3. The arm 4 comprises several elongate boxes 4a, 4b, 4c and 4d, fitted into one another in a longitudinal direction with axis A4 perpendicular to axis Y4. The operation of the telescoping arm 4 is known in itself. Alternatively, the arm 4 can be an articulated hoisting arm or an arm of any other known type.

Arranged at the end 4d of the arm 4 is a parallelogram structure 5, supporting a platform 6. The platform 6 is provided to receive a load, in particular personnel and equipment. The maximum admissible load value depends on the dimensions and the 25 mechanical strength of the various elements of the lift 1. In motion on a surface on the ground S, when the tower is oriented at 0 degrees, the operator of the lift 1, not shown, is positioned on the platform 6 and looks toward a front side 8 opposite a rear side 9 of the lift 1.

As shown in FIG. 2, the lift 1 comprises a right rear half axle 20, a left rear half 30 axle 40, a right front half axle 60, and a left front half axle 80. The chassis 2 has a generally parallelepiped shape, with four corners each comprising a structural element 12, 14, 16 or 18. Each half axle 20, 40, 60 or 80 is articulated on one of the elements of the structure, respectively 12, 14, 16 or 18, belonging to the chassis 2. Each half axle 20, 40, 60 or 80 is provided with a wheel 22, 42, 62 or 82, respectively, which can be oriented 35 individually relative to the chassis 2, i.e. independently of the orientation of the other wheels. FIGS. 1 to 11 show the half axles 20-80 in different configurations C11, C12, C13, C14, C15, C16 and C17 of the lift 1, which will be outlined below. In particular, FIGS. 9 and 10 show the wheels 22-82 bearing on a surface on the ground S, while the relief of the ground S varies.

A reference plane P2 is defined associated with the chassis 2, said plane P2 being substantially parallel to the ground S when the lift 1 rests on 5 the ground S. More specifically, the plane P2 is defined as the plane tangent to the flat upper surfaces of the elements 12-18 of the chassis 2. The terms “horizontal,” “vertical,” “top” and “bottom” are defined relative to the plane P2 and the ground S. For simplification purposes, it will be considered that the axis X2 is situated in plane P2. In configurations C11, C12, C13, C14, 10 C15 and C16 of the lift 1, shown in FIGS. 1 and 3 to 10, the axes X2, Y4 and Z3 are perpendicular to one another. Irrespective of the configuration of the lift 1, the plane P2 is parallel to the axis Y4 and perpendicular to the axis Z3.

Hereafter, for simplification purposes, the description is done primarily in reference to half axle 20, with the understanding that the explanations are also valid for half axles 15 40, 60 and 80.

The half axle 20 extends between the structural element 12 and the wheel 22. The half axle 20 comprises a pivot system 24 with axis Z24, a system 26 with axis A26 made up of an outer box 27 and an inner box 28, an actuating system 30 with axis Z30 made up of a cylinder body 31, a cylinder rod 32 and measuring means 33, a rotating system 34 20 with axis Z30 made up of a support 35 and a pivoting device 36, a shaft 37 and a hub 38 supporting the wheel 22.

The shaft 37 is the end of the half axle 20 on which the hub 38 of the wheel 22 is mechanically engaged. The shaft 37 is rotatably mobile relative to the system 34 around a horizontal axis Y22, which is parallel to plane P2 and perpendicular to axis Z30 of the 25 systems 30 and 34. In other words, the axis Y22 is the axis of rotation of the wheel 22 when the lift 1 travels on the ground S, as shown in FIGS. 9 and 10.

The pivot system 24 forms a pivot link with vertical axis Z24 perpendicular to the plane P2 between the element 12 and the outer box 27, which can pivot relative to the chassis 2. The system 24 comprises means for rotating the half axle 20 horizontally 30 relative to the chassis 2, for example including a helical or electric cylinder specific to it. The system 24 can also comprise a sensor for torque exerted on the system 24 around the axis Z24, a sensor for vertical force exerted by the half axle 20 on the element 12 of the chassis 2 in reaction to the bearing of the wheel 22 on the ground S, and a sensor for the angular position of the box 27 relative to the element 12 of the frame 2. These 35 component elements of the system 24 are not shown for simplification reasons.

The system 26 constitutes extension and retraction means of the system 30, the system 34, the shaft 37 and the wheel 22 relative to the element 12 of the chassis 2, in the horizontal direction defined by the sliding axis A26. To that end, the inner box 28 is slidingly mounted in the outer box 27 along the horizontal axis A26, which is parallel to the plane P2 and perpendicular to the axes Z24 and Z30. As shown in FIGS. 5 9 and 10, the system 26 can be extended between a length L26A and a length L26B, measured horizontally between the axes Z24 and Z30. The system 26 comprises means for telescoping movement of the box 28 relative to the box 27 along the sliding axis A26, preferably including a cylinder specific to it, not visible as it is positioned in the system 26. The system 26 can also comprise a sensor for the linear position of the box 28 relative to the box 27 along the sliding axis A26 and/or an end-of-travel contact. These component elements of the system 26 are not shown, for simplification purposes.

The actuating system 30 extends along the vertical axis Z30, which is parallel to the axis Z24 and perpendicular to the plane P2. The system 30 is situated at the end of 15 the system 26 that is opposite the element 12. The system 30 is configured like a cylinder, the body 31 of which is secured to the box 28, while the end of the rod 32 is secured to a support 35. Advantageously, the system 30 can be a cylinder that extends along the hoisting axis Z30, in particular a hydraulic, electric or pneumatic cylinder, or an electric actuator. The rod 32 can move relative to the body 31 in telescoping translation along the 20 axis Z30. In other words, the system 30 constitutes means for vertical translation of the wheel 22 relative to the chassis 2. The system 30 makes it possible to adapt the configuration of the half axle 20 to the terrain and performs a stabilizing function. Preferably, the system 30 is configured to translate the shaft 37 and the wheel 22 along the hoisting axis Z30 independently of other internal mobilities of the half axle 20. As 25 shown in FIGS. 9 and 10, the system 30 can be extended between a length L30A and a length L30B, measured vertically between the plane P2 and the axis Y22. Preferably, the system 30 also comprises sensors for the position of the rod 32 relative to the body 31 and/or an end-of-travel contact for the translational travel. In particular, the system 30 can comprise a sensor for the linear position of the rod 32 along the axis Z30. For 30 simplification purposes, these component elements of the system 30 are not shown.

Alternatively, the actuating system 30 can extend along a hoisting axis Z30 that is permanently tilted by an angle α30 greater than 60 degrees relative to the plane P2, preferably comprised between 75 degrees and 90 degrees, inclusive, relative to the plane P2. In that case, the incline angle α30 of the axis Z30 relative to the plane P2 is constant 35 and, preferably, the axis Z30 is situated in a vertical plane comprising the axis A26. Such an incline of the axis Z30 procures both satisfactory mobility and stability of the half axle 20 of the lift 1. If the incline of the axis Z30 relative to the plane P2 were to be smaller than 60 degrees, permanently or even temporarily, the half axle 20 would not absorb the forces resulting from the weight of the lift as well. In FIGS. 1 and 2, the incline angle α30 is equal to 90°.

The rotating system 34 comprises the support 35 and the pivoting device 36, which is rotatably movable relative to the support 35 around the axis Z30. The support 35 is secured to the end of the rod 32 of the system 30, while the device 36 supports the shaft 37. The system 34 comprises means for rotating the device 36, the shaft 37 and the wheel 22 horizontally relative to the support 35 and the system 30, for example including a 10 helical or electric cylinder specific to it. In other words, the system 34 forms a pivot link with vertical axis Z30 between the shaft 37 and the system 30. The system 34 can also comprise a sensor for the torque exerted on the system 34 around the axis Z30. The system 34 can also comprise a sensor of the angular position of the device 36 and the shaft 37 relative to the support 35 around the axis Z30, making it possible to determine 15 the orientation of the shaft 37 and/or the axis Y22 of the wheel 22 relative to the axes Z30 and A26. These component elements of the system 34 are not shown, for simplification purposes.

Traditionally, a half axle may be load-bearing, guiding and/or driving.

In the case at hand, the half axle 20 is configured on the one hand to support the component elements 2 to 6 of the lift 1, and on the other hand to orient the movements of the lift 1 on the ground S as a function of the orientation of the wheel 22 relative to the chassis 2. In the case where the half axle 20 incorporates means for transmitting a rotational movement of the wheel 22 around its axis Y22, the half axle 20 is also driving. These transmission means can receive a driving torque coming from the motor means of 25 the chassis 2, or specific to the half axle 20.

In one alternative not shown, the systems 24, 26, 30 and 34 can each have a construction different from that of FIGS. 1 to 11 without going beyond the scope of the invention. For example, the systems 30 and 34 can be built as a single actuating system comprising means for moving the shaft 37 and the wheel 22, on the one hand in 30 translation along the axis Z30, and on the other hand in rotation around the axis Z30. According to another example, the systems 24 and 34 ensuring rotational mobility can have similar constructions. Preferably, irrespective of the construction of the systems 24, 26, 30 and 34, the half axle 20 has two rotational mobilities around vertical axes, as well as two translational mobilities along a horizontal axis and a vertical axis.

The component elements of the half axles 40, 60 and 80 are similar to the component elements of the half axle 20, and bear the same numerical references respectively increased by 20, 40 and 60. These are pivot systems 44, 64, 84 with axes Z44, Z64, Z84 systems 46, 66, 86 with axes A26, A46, A86 each made up of a pivoting outer box 47, 67, 87 and a sliding inner box 48, 68, 88, actuating systems 50, 70, 90 with axes Z50, Z70, Z90 each made up of a cylinder body 51, 71, 91, a cylinder rod 52, 72, 92 and measuring means 53, 73, 93, rotating systems 54, 74, 94 each made 5 up of a support 55, 75, 95 and a pivoting device 56, 76, 96, shafts 57, 77, 97 and hubs 58, 78, 98 supporting the wheels 42, 62, 82.

Owing to the half axles 20-80, the lift 1 can move on the ground S in all directions, longitudinally, laterally and diagonally, and not only forward 8 or backward 9 along the 10 longitudinal axis X2 of the chassis 2. In other words, during operation, the lift 1 does not have a primarily front-back orientation. Furthermore, the half axles 20-80 allow the lift 1 to be deployed with optimal stability as a function of the usage constraints, in particular its environment.

The spacing between the rear wheels 22 and 42 on the one hand and the front 15 wheels 62 and 82 on the other hand, considered in the direction of the length of the lift 1, is called “wheelbase.” The spacing between the rear wheels 22 and 42, or between the front wheels 62 and 82, considered in the direction of the width of the lift 1, is called “track width.” In most configurations of the lift 1, the width thereof is smaller than the length and, as a result, the track width is smaller than the wheelbase.

FIGS. 3 and 4 show the lift 1 in an extended configuration C11, procuring maximal stability. The lift 1 then has a track width V11 and a wheelbase E11. The systems 26, 46, 66 and 86 are extended toward the outside, opposite the axis Z3. Owing to the systems 24, 44, 64 and 84, the axes A26, A46, A66 and A86 are each inclined by a 45 degree angle relative to the axis X2, along a projection normal to the plane P2, with the 25 half axles 20 and 40 oriented toward the rear 9 and the half axles 60 and 80 oriented toward the front 8. Owing to the system 34, 54, 74 and 94, the axes Y22 to Y82 of the wheels 22 to 82 are oriented perpendicular to the axis X2, along a projection normal to the plane P2. The axes Y22 and Y42 are substantially aligned. The axes Y62 and Y82 are substantially aligned.

In practice, the ratio between the track width V11 and the wheelbase E11 of the lift 1 is optimal. When the tower 3 rotates by 360 degrees, the stability of the lift 1 varies as a function of the position of that tower 3 and the other moving elements: lifting arm 4, structure 5, platform 6 and its occupants. In the extended configuration C11, the stability of the lift 1 varies little during operation, irrespective of the rotational position of the tower 35 3 and the other moving elements 4, 5 and 6. In this configuration C11, the lift 1 can move by running on the wheels 22-82, even if the cantilever between the chassis and the wheels 22-82 is significant.

FIGS. 5 and 6 show the lift 1 in a compact configuration C12, procuring a minimal bulk. The lift 1 then has a track width V12 and a wheelbase E12. The systems 26, 46, 66 and 86 are retracted. The half axles 20-80 are oriented toward the front 5 8, with the axes A26-A86 parallel to the axis X2. The wheels 22-82 are folded on either side of the chassis, with the axes Y22-Y82 perpendicular to the axis X2, along a projection normal to the plane P2. The following axes are substantially aligned two by two: Y22 and Y42, Y62 and Y82, A26 and A66, A46 and A86.

A comparison of FIGS. 4, 6 and 8 shows that the compact configuration C12 of FIG. 6 in fact procures a minimal footprint, without preventing the wheels 22-82 from rotating around their respective axes Y22-Y82. The lift 1 can then pass through a narrow passage, or enter or leave a container or trailer when it is loaded or unloaded. The track width V12 is minimal, while the wheelbase E12 is reduced, but not minimal.

According to a compact configuration alternative, not preferred, the front half axles 60 and 80 can be oriented toward the rear 9. In that case, the wheelbase is smaller than E12. Compared with the compact configuration C12, the bulk gain is small, while the stability decreases. In particular, there is then a risk of tilting the lift 1 forward 8.

FIGS. 7 and 8 show the lift 1 in a lateral movement configuration C13, i.e. moving 20 in a horizontal direction normal to the axis X2. The lift 1 then has a track width V13 and a wheelbase E13. The systems 26, 46, 66 and 86 are retracted, so as to limit the cantilever between the chassis 2 and the wheels 22-82. The axes A26, A46, A66 and A86 are each inclined by an angle of 90 degrees relative to the axis X2, along a projection normal to the plane P2. The axes Y22-Y82 of the wheels 22-82 are parallel to the axis X2, along a 25 projection normal to the plane P2. The following axes are substantially aligned two by two: Y22 and Y62, Y42 and Y82, A26 and A46, A66 and A86. The lift 1 can then “crabwalk,” which is particularly advantageous in certain situations, for example to run alongside an obstacle above which the arm 4 extends. The track width V13 is larger than the track width V12 and smaller than the track width V11. Likewise, the wheelbase E13 is larger 30 than the wheelbase E12 and smaller than the wheelbase E11.

In particular, the configuration C13 of FIGS. 7 and 8 is well suited to the horizontal translation of the wheels 22-82 relative to the chassis 2, under the action of the horizontal extension and retraction systems 26-86. In FIG. 8, the half axles 20 and 40 are also shown in broken lines in a configuration C13, which is also well suited to the movement of 35 the wheels 22-82 along the axes A26-A86. This configuration C13 is obtained from the configuration C11, after pivoting the wheels 22 and 42 around the axes Z30 and Z50 owing to the systems 34 and 54. In configurations C13 and C14, the axes Y22-Y82 of the wheels 22-82 are perpendicular to the axes A26-A86, in other words the wheels 22-82 are aligned along the axes A26-A86. In this way, the horizontal extension or retraction of the wheels 22-82, along the sliding axes A26-A86, can be done without scraping on the ground S, 5 as outlined below.

In practice, there are three horizontal deployment modes of the half axles 20-80. The lift can use any of the deployment modes, as a function of the usage constraints and the operator's assessment. Before choosing a particular mode, the operator visually identifies the deployment limits of the lift 1, in particular the obstacles on the ground S. The operator can also be assisted by the central processing unit in making his decision, said unit being able to be configured to interpret information received from proximity sensors distributed on the perimeter of the lift 1.

The first and second extension modes correspond to a dynamic exit of the half axles 20-80, without it being necessary to raise the chassis 2. When the lift 1 is stopped, 15 the extension is hindered, or made impossible, by the friction of the wheels on the ground S. Furthermore, such friction can damage the ground S and the wheels by shearing.

The first extension mode can be activated when the lift 1 is moved, above a certain speed and when there is sufficient space. In that case, the lift 1 moves forward or backward, while each half axle is gradually moved from the retracted position to the 20 extended position, or vice versa. This first embodiment is not suitable when the lift 1 is in a limited space, for example close to a wall or a pit, or when the ground S is loose and/or likely to be damaged.

The second extension mode can be activated in a confined area, when a front-to-hack movement of the lift 1 is impossible. This embodiment uses the rotary system 34, in 25 other words the means for rotating the shaft 37 and the wheel 22 around the axis Z30. The system 26 and the system 34 communicate with one another, directly or via the central processing unit. When the system 26 receives an extension or retraction order, it informs the system 34, before the extension or retraction of the wheel 22, the shaft 37 and the systems 30 and 34 relative to the element 12. The system 34 is then configured so 30 that the device 36 pivots relative to the support 35 around the axis Z30, thereby moving the axis of rotation Y22 of the wheel 22 until the axis Y22 reaches a direction perpendicular to the sliding axis A26. As a result, when the system 26 is deployed along the axis A26, the wheel 22 rolls on the ground S without damaging it. The same is true for each of the half axles 20-80.

The third extension mode can be activated in a confined space or when the terrain is particularly uneven. This mode uses the actuating system 30, in other words the means for translating the shaft 37 and the wheel 22 along the axis Z30. The same is true for each of the half axles 20-80. The chassis 2 is raised by the vertical extension of at least three of the half axles 20-80 and, at the same time, the remaining half axle can be reconfigured without its wheel touching the ground. For example, when the half axle 20 is deployed or retracted, the three wheels 42, 62 and 82 of the lift 1 bear on the ground 5 S, while the wheel 22 belonging to the half axle 20 being deployed or retracted is horizontally and/or vertically movable away from the ground S. Then, the same operation is repeated for each of the half axles 40-80 that must be deployed or retracted. In this way, the ground is not damaged by the movement of the wheels 22-82. Lastly, the chassis 2 lowers again and all of the wheels 22-82 again rest on the ground S.

In particular, the existing vehicle and half axles are not suitable for implementing the second and third extension modes.

Furthermore, it will be noted that the track width V of the lift 1 is maximal when, on the one hand, the axes A26-A86 are inclined by a 90 degree angle relative to the axis X2, 15 in projection normal to the plane P2 and, on the other hand, the systems 26-86 are extended along those axes A26-A86. It will also be noted that the wheelbase E is maximal when, on the one hand, the axes A26-A86 are parallel to the axis X2 and, on the other hand, the systems 26-86 are extended along those axes A26-A86. However, in either case, the stability of the lift 1 is not maximal. In fact, a satisfactory stability level results 20 from a compromise between the track width and the wheelbase.

FIGS. 9 and 10 show the lift 1 bearing on the ground S, in two different longitudinal movement configurations, a configuration C15 and another, more extended configuration C16, respectively. The configuration C15 is comparable to the extended configuration C11 and represents an intermediate configuration before extension of the 25 systems 26-86. In configuration C15, the system 26 extends horizontally along the length L26A, the system 30 extends vertically along the length L30A, while the lift 1 has the track width V15. In configuration C16, the system 26 extends horizontally along the length L26B larger than the length L26A, the system 30 extends vertically along the length L30B larger than the length L30A, while the lift 1 has a track width V16 larger than the track width V15.

Thus, in the configuration C16 of FIG. 10, the half axle 20 is deployed to adapt to the height difference of the ground S. Each of the translations of axis A26 or Z30 is independent of the other mobilities of the half axle 20, in particular independent of the rotations around the axes Z24 and Z30. Furthermore, the mobilities of the half axle 20 are independent of the mobilities of the other half axles 40, 60 and 80. In other words, each 35 half axle 20-80 is mechanically independent of the other half axles equipping the lift 1.

FIG. 11 shows the half axle 20 of the lift 1, in a configuration C17 pivoting around the axis Z24, owing to the system 24. This configuration C17 is obtained from the extended configuration C11, after pivoting the wheel 22 around the axis Z30 owing to the system 34. The system 26 is extended, while the system 34 keeps the axis Y22 of the wheel 22 aligned along the axis A26. The configuration C17 is well suited 5 to the rotation of the wheel 22 relative to the chassis 2 around the axis Z24, under the action of the system 24. The wheel 22 rolls on the ground following an arc of circle, describing a maximum travel angle β24 equal to 180°. During this pivoting, the axis Y22 always stays perpendicular to said arc of circle.

Preferably, the system 24 and the system 34 communicate with one another, directly or via the central processing unit. When the system 24 receives a pivot order, it informs the system 34, before pivoting of the boxes 27, 28 of the system 26 relative to the element 12. The system 34 is then configured so that the device 36 pivots relative to the support 35 around the axis Z30, thereby moving the axis of rotation Y22 of the wheel 22 15 until the axis Y22 reaches a direction perpendicular to the pivot axis Z24. In this way, the wheel 22 rolls on the ground in an arc of circle while minimizing friction on the ground.

In practice, the systems of the half axles 20-80 can be controlled, independently or in a synchronized manner, by the electronic central processing unit mounted on the chassis 2 and steered by the operator of the lift 1. The central unit can be equipped with 20 gyroscopic systems adapted to continuously determine the position of the center of gravity of the lift 1. The central unit can also use the measurements for the vertical force sensors incorporated into each of the pivot systems 24, 44, 64 and 84, or preferably use the measurements from the sensors 33, 53, 73, 93 incorporated into the actuating systems 30, 50, 70 and 90. In fact, the systems 30-90 are closer to the wheels 22-82 and better 25 suited than the systems 24-84 to measure the forces exerted by the ground S, in reaction to the bearing of the wheels 22-82 and the lift 1, on the corresponding half axle 20-80. Alternatively, the central unit can cross-check the measurements from the different sensors. Furthermore, the central unit can continuously calculate a tilt percentage of the lift 1. Determining the center of gravity and the tilt percentage of the lift 1 makes it possible 30 to obtain better intelligence in the deployment logic of the half axles 20-80.

As a function of the calculations by the central unit, it is possible to consider offsetting the irregularities of the ground S, for example by keeping the reference plane P2 substantially parallel to the ground S. Alternatively, in case of major height differences of the ground S, the central unit can be configured to control the half axles 20-80, 35 automatically or after manual validation by the operator, so as to optimize the incline of the reference plane P2 relative to the ground S and the earth's gravitational pull. At that stage, it will be noted that the lift is not suitable for use on an overly uneven or sloped terrain, on which the risk of accidents is too high. In order to prevent the lift 1 from sliding on a small slope, each half axle 20-80 can comprise braking means and/or means for locking the wheels 22-82. These braking and/or locking means can be controlled by the operator and/or automatically by the central unit. Each wheel 22-5 82 can be braked individually.

Preferably, the electronic central control unit mounted on the chassis 2 makes it possible to calculate the maximum admissible reach of the platform 6 as a function of various parameters, such as: the rotation of the tower 3, the extension of the telescoping 10 arm 4, the load of the platform 6, the track width V between wheels and/or the incline of the terrain. Any suitable parameter may or may not be taken into account, selectively. In a simplified manner, the calculation of the maximum admissible reach may not depend on the rotation of the tower 3, but incorporate the least favorable case: when the tower 3 and the arm 4 are oriented at 90 degrees from the axis X2 of the chassis 2.

In this way, the lift 1 has a good capacity to adapt to its environment.

Preferably, the half axles 20-80 all have the same construction, such that the lift 1 is simpler and less expensive to produce. Furthermore, the symmetrical elements between the half axles 20-80 facilitate the various movements by the central unit. Each half axle 20-80 only comprises means for rotating around vertical axes and translation 20 means, but not means for rotating around horizontal axes. In fact, the rotations of horizontal axes use pivot links that do not absorb the forces resulting from the weight of the lift as well. In particular, the translation means are configured to perform telescoping translation with a vertical axis and telescoping translation with a horizontal axis.

Also preferably, each half axle 20-80 incorporates means for transmitting a 25 rotational movement to the wheel 22-82. These transmission means, not shown for simplification purposes, are configured to receive a driving torque coming from the motor means of the chassis. In that case, each half axle 20-80 is driving.

Alternatively, each half axle 20-80 can comprise an independent motor adapted to provide torque to the means for rotating the wheel.

In an alternative not shown, the half axles 20-80 can have certain differences relative to one another. Irrespective of the embodiment, each half axle 20-80 according to the invention at least comprises means for translating the wheel 22-82 relative to the chassis 2, in a direction inclined by at least 60 degrees relative to the plane P2, preferably a vertical direction perpendicular to the plane P2.

According to one particular alternative not shown, the lift can comprise a combination of driving and/or guiding half axles 20-80. For example, the half axles 20 and can be driving and guiding, while the half axles 60 and 80 can be guiding only.

According to another particular alternative not shown, the lift comprises more than four half axles, which can be identical or of different types. For example, 5 a lift equipped with six half axles can comprise two guiding half axles, two driving half axles, and two load-bearing half axles. According to another example, each of the half axles is loadbearing, guiding and driving.

The invention has been shown in the case where it is used with a vehicle of the aerial lift type. The invention is applicable to all public works, handling or lifting vehicles, such as power shovels, power lift trucks, order pickers, or cranes.

1. A half axle (20) articulated on a structural element (2, 12) of a vehicle (1), the half axle (20) including a wheel (22) rotatably movable around an axis of rotation (Y22) relative to a shaft (37), the structural element (2, 12) defining a reference plane (P2) substantially parallel to the ground (S) when the wheel (22) rests on the ground (S), the half axle (20) also comprising a pivot system (24) for pivoting relative to the structural element (2, 12) around a pivot axis (Z24), wherein the half axle (20) also comprises an actuating system (30) including means for translating the wheel (22) along a hoisting axis (Z30) permanently tilted by an incline angle (α30) comprised between 60 degrees and 90 degrees, inclusive, relative to the reference plane (P2).

2. The half axle (20) according to claim 1, wherein the pivot axis (Z24) of the half axle (20) is perpendicular to the reference plane (P2) and stationary relative to the structural element (2, 12) and wherein in that the hoisting axis (Z30) of the actuating system (30) is substantially perpendicular to the reference plane (P2), with the incline angle (α30) equal to 90 degrees.

3. The half axle (20) according to claim 1, wherein the actuating system (30) comprises a cylinder (31-32) that extends along the hoisting axis (Z30), preferably a hydraulic cylinder.

4. The half axle (20) according to claim 1, wherein it also comprises rotating means (34) for rotating the wheel (22) around the hoisting axis (Z30).

5. The half axle (20) according to claim 1, wherein it also comprises a system (26) for extending and retracting the wheel (22) relative to the structural element (2, 12) along a sliding axis (A26) parallel to the reference plane (P2).

6. The half axle (20) according to claim 1, wherein it comprises means (24; 33) for measuring pressure or forces exerted between the ground (S) and the half axle (20) along a measuring axis (Z24; Z30) perpendicular to the reference plane (P2).

7. The half axle (20) according to claim 1, wherein it comprises rotating means (24, 30) for rotating around axes (Z24, Z30) only perpendicular to the reference plane (P2) and translation means (26, 30), in particular a telescoping translation along an axis (Z30) perpendicular to the reference plane (P2) and a telescoping translation along an axis (Z26) parallel to the reference plane (P2).

8. A method for using a half axle (20) according to claim 4, said method comprising at least the following successive steps:
a1) the pivot system (24) receives an order to pivot the half axle (20) around the pivot axis (Z24) and informs the rotating means (34) for rotating the wheel (22) around the hoisting axis (Z30),
b1) the rotating means (34) move the axis of rotation (Y22) of the wheel (22) until said axis of rotation (Y22) is aligned in a direction perpendicular to the pivot axis (Z24),
c1) the pivot system (24) pivots the wheel (22) relative to the structural element (2, 12) according to the order received in step a1).

9. A method for using a half axle (20) according to claim 5, the half axle (20) including rotating means (34) for rotating the wheel (22) around the hoisting axis (Z30), said method comprising at least the following successive steps:
a2) the extension and retraction system (26) receives an order to extend or retract the wheel (22) along the sliding axis (A26) and informs the rotating means (34) for rotating the wheel (22) around the hoisting axis (Z30),
b2) the rotating means (34) move the axis of rotation (Y22) of the wheel (22) until said axis of rotation (Y22) is aligned in a direction perpendicular to the sliding axis (A26),
c2) the extension and retraction system (26) extends or retracts the wheel (22) relative to the structural element (2, 12) according to the order received in step a2).

10. The method according to claim 9, comprising a step d2) following step c2), this step d2) consisting of moving the axis of rotation (Y22) of the wheel (22), under the action of the rotating means (34) around the hoisting axis (Z30), until said axis of rotation (Y22) reaches a position corresponding to that of step a2) or another predefined position.

11. A vehicle (1), in particular of the aerial lift type, equipped with a chassis (2) comprising at least one structural element (12, 14, 16, 18), wherein it is also equipped with at least one half axle (20; 20, 40, 60, 80) according to one of the preceding claims, the or each half axle (20; 20, 40, 60, 80) being articulated to one of the structural elements (12, 14, 16, 18) of the chassis (2).

12. The vehicle (1) according to claim 11, wherein it comprises at least four half axles (20, 40, 60, 80), each half axle being articulated to one of the structural elements (12, 14, 16, 18) of the chassis (2) and being mechanically independent of the other half axles equipping the vehicle (1).

13. The vehicle (1) according to claim 12, wherein at least four half axles (20, 40, 60, 80) each comprise means (24, 44, 64, 86; 33, 53, 73, 93) for measuring pressure or forces exerted between the ground (S) and the half axle along a measuring axis perpendicular to the reference plane (P2) and in that the vehicle (1) comprises an electronic management unit that is connected to the measuring means and configured to determine a position of the center of gravity of the vehicle (1) and/or a tilt percentage of the vehicle (1).

14. A method for using a vehicle (1) according to claim 12, wherein when one (20) of the half axles (20, 40, 60, 80) is deployed or retracted, at least three wheels (42, 62, 82) of the vehicle (1) are bearing on the ground (S), while the wheel (22) belonging to the half axle (20) being deployed or retracted is horizontally and/or vertically mobile at a distance from the ground (S).
